(19) United States
(12) Patent Application Publication
(10) Pub. No.: US 2008/0071630 A1
(43) Pub. Date: Mar. 20, 2008

(54) AUTOMATIC CLASSIFICATION OF PROSPECTS

(75) Inventor: John J. Donahue, Melrose, MA (US)

Correspondence Address: BANNER & WITCOFF, LTD., 1100 13th STREET, N.W., SUITE 1200, WASHINGTON, DC, 20005-4051, US

(73) Assignee: J.J. DONAHUE & COMPANY, Boston, MA (US)

(21) Appl. No.: 11/532,078

(22) Filed: Sep. 14, 2006

(51) Int. Cl. G06Q 30/00

(52) U.S. Cl. 705/26

(57) ABSTRACT

A system and method for automatically identifying customers with potential for completing a transaction and facilitating the transaction is provided herein. Visitors to a website or listing posted thereon may be identified and characterized according to publicly available information and/or other information provided by the visitor. Attributes of a visitor may be compared to one or more predefined evaluation variables and criteria. The evaluation variables and criteria are used to determine a probability that the visitor will complete a transaction. Points may be assigned for matching variables. Visitors may be categorized according to a determining probability. If a visitor has a sufficiently high probability, a counterparty to the transaction may be contacted. A transaction system may further be used to facilitate the transaction between the visitor and the counterparty. The variables and algorithms used to evaluate visitors may further be refined based on information from completion of past transactions.

### FIELD OF ART

The invention relates generally to electronic commerce. More particularly, the invention provides a method and system for identifying potential customers for a transaction based on a probability that the transaction will be completed and/or successful.

### BACKGROUND

With the advent of global networks such as the Internet, many companies, organizations and business minded individuals have established a presence on the Internet to facilitate commercial transactions and broaden their customer base. For example, companies have frequently created websites and web pages for advertising and selling their products and/or services. Similarly, auction sites have also become a significant resource in allowing individuals to sell their products and/or services. Potential customers throughout the world are able to access such websites, view the products and even purchase items that they find attractive and/or useful.

In many industries, however, transactions might not be as simple as a customer selecting a product or service and submitting payment information. For example, real estate transactions often involve extensive negotiations and multi-step processes before a transaction may be completed. These processes may include obtaining inspection reports, assessing the property and/or deciding on the terms of the lease or contract. In another example, car salesmen regularly find themselves engaging in hours of negotiations prior to reaching an agreement with a potential customer. The amount of time spent on a transaction may further be increased by the number of details and factors associated with the type of sale. If a transaction is not successful or completed, the time and resources associated with such negotiations and processes may represent significant costs, lost profits and/or lost business.

Customer characteristics may influence whether a transaction is successful or completed. For example, a potential buyer's place of residence may heavily impact whether the potential buyer purchases a property in another state or country. Similarly, a potential car buyer's occupation may reflect the type of car that he or she is most likely to purchase. However, conventional Internet sales methods often lack easy access to certain attributes of potential customers (including prospective renters or users of a service) that can determine the probability that negotiations and/or discussions with a particular customer will result in a successful or completed transaction.

Additionally, many potential customers who may be considered high probability targets may not contact a sales person or company to enter the negotiation or transaction process. For example, some potential customers may be too shy or indecisive to contact the sales person or company. However, such customers may be receptive to contact by the sales company or person after they have obtained information about goods or services through a medium such as the Internet, and in so doing may provide certain information that may be useful in forming a basis for further discussions and/or determining the probability that such contacts may be fruitful. Consequently, conventional Internet sales methods that rely on potential customers to initiate contact may miss out on opportunities to realize sales from those potential customers who do not actively contact or seek out the selling party, but who would be comfortable with an approach through an electronic medium.

For the foregoing reasons, a system and method for determining probabilities that potential customers will complete a transaction is needed.

### SUMMARY

Many of the aforementioned problems are solved by a system and method for identifying visitors to a website who have accessed particular listings and associating these visitors with particular attributes that may correspond to a predefined probability for completing a transaction. Information about each visitor viewing the website and/or a specific listing may be determined based on information received upon the visitor accessing the website and/or using publicly available data. This information about each visitor may be compared to one or more variables and match criteria associated with a listing or website to determine a transaction completion probability score or category. The determination may be made based on various algorithmic formulas. For example, if the visitor information matches one or more predefined evaluation variables, a match value may be added to the visitor's probability score. Match values may also be deducted if a non-match is detected or if certain other variables and/or match criteria correlated negatively with success are detected. This could include, for example, visitors from a certain uniform record locator (URL) that is associated with users who are unlikely to be “deal makers”.

The visitor may further be automatically classified or categorized based on his or her score, or the summary of all the positive and negative match values. For example, the visitor's probability score may be compared to a predefined qualification threshold. If the visitor's score meets the threshold, the visitor may be categorized or classified in a particular group or level. Information about the visitor may be provided to a counterparty or affiliated third party associated with the visited listing including certain “ascriptive” attributes such as contact information, name, employer and the like along with other “non-ascriptive” attributes such as information gleaned from a URL referrer code or other information provided directly by the visitor. The system and method may further automatically initiate contact with the visitor if the visitor meets the predefined threshold and if certain minimum information is provided to permit contact (e.g., reference to a company name or an email address).

In another aspect, a visitor may be evaluated through a contact management system to determine an appropriate level and/or type of contact. For example, the contact management system may determine whether visitors to a listing should be contacted and whether an e-mail, a phone call or a physical letter would be most appropriate. The contact management system may further log communications and/or other interactions to and from the visitor and/or counterparty associated with the listing. Additionally, the contact management system may also act as a transition system for determining a point at which a transaction between a visitor and a counterparty has begun and then transitioning the visitor and the counterparty to a transaction facilitation system. For example, if the contact management system determines that a visitor and counterparty have progressed to a negotiations stage, each of the visitor and the counter party may receive information for connecting to an on-line transaction facilitation system. Once connected into this transaction system, each party may then follow the link to begin or continue negotiations and/or other transaction processes with their respective counterparty. Transaction progress and data may further be logged by the transaction system and later reported to the server/user hosting the web listings.

In yet another aspect, the methods and/or algorithms by which a visitor's probability of transaction completion is determined may be refined based on whether a transaction is completed. That is, if a visitor completes a transaction, success factors may be identified from a transaction data log and applied to evaluations of future visitors. Success factors may include the variables and/or match criteria that matched the visitor's ascriptive attributes, or certain other non-ascriptive attributes that would correlate positively with completing a transaction. If a transaction is completed, the success factors may be validated or added to the system. Validation may include increasing a weight of a variable or match criterion and/or flagging a variable and/or match criterion as a confirmed success factor. If a success factor is not represented in the variables and/or criteria used to predict this outcome (e.g., the city in which the party lives), it may be added for future evaluations. Variables and/or match criteria that did not contribute to success may be removed or may have their match values decreased.

These as well as other advantages and aspects of the invention are apparent and understood from the following detailed description of the invention, the attached claims, and the accompanying drawings.

### BRIEF DESCRIPTION OF THE DRAWINGS

The present invention is illustrated by way of example and not limited in the accompanying figures in which like reference numerals indicate similar elements and in which:

FIG. 1 illustrates a computer networking environment in which one or more of the aspects described herein may be implemented.

FIG. 2 illustrates a web page displaying multiple listings according to one or more aspects described herein.

FIG. 3 is a flowchart illustrating a method for identifying visitors having a probability for completing a transaction and facilitating transactions between the visitors and one or more third parties according to one or more aspects described herein.

FIG. 4 is a flowchart illustrating a method for evaluating a visitor's probability of transaction completion according to one or more aspects described herein.

FIG. 5 illustrates a table storing variables, criteria and properties associated therewith for evaluating a visitor's probability for completing a transaction according to one or more aspects described herein.

FIG. 6 is a graphical representation of a visitor evaluation process according to one or more aspects described herein.

FIG. 7 illustrates a message for linking a visitor and/or a counterparty to a transaction system according to one or more aspects described herein.

FIG. 8 illustrates a user interface displaying a comparison between predictive scores and actual scores according to one or more aspects described herein.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

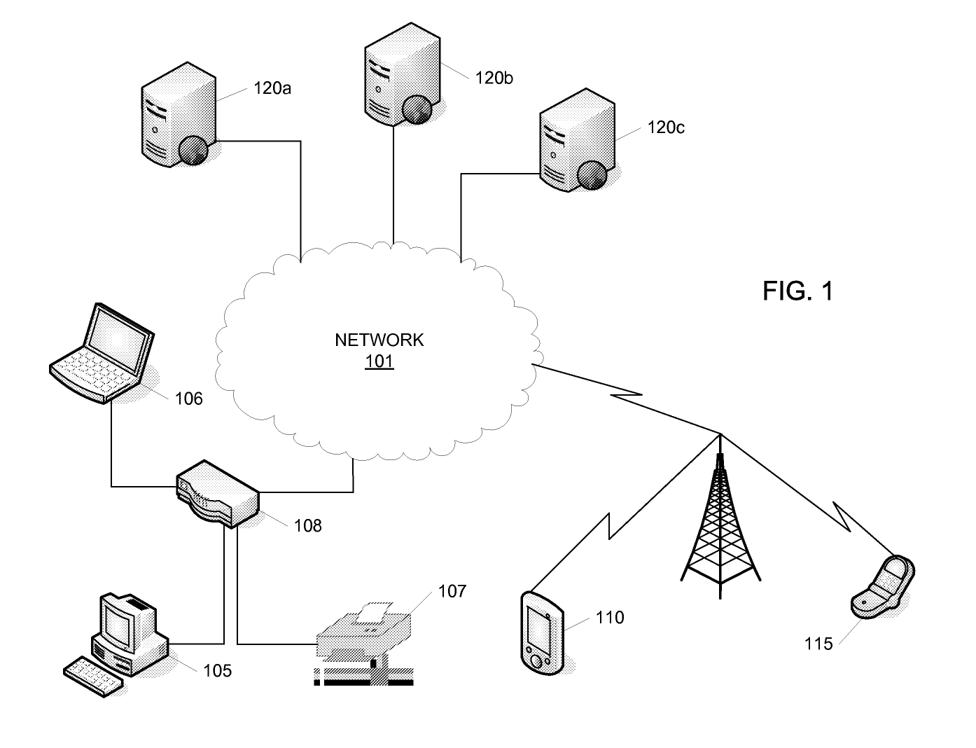

FIG. 1 illustrates a computer networking environment in which one or more of the aspects described herein may be implemented. The networking environment may be built on a global network 101 such as the Internet. One or more devices such as personal computer (PC) 105, laptop 106, printer 107, personal digital assistant (PDA) 110 and cellular telephone 115 may connect to network 101 through either wired or wireless network links or both. In one arrangement, PC 105 may connect to wired local area network (LAN) router 108 that facilitates access to network 101 through a Internet service provider (ISP). Alternatively, cellular telephone 115 and/or PDA 110 may access network 101 via wireless networks established over communication networks such as cellular communication networks, satellite communication links, radio frequency (RF) networks and the like. In one or more arrangements, devices 105, 106, 107, 110 and 115 may access network 101 using either wired and wireless networking methods or both.

The network environment may further include content servers 120 that store network-accessible data such as web pages, multimedia files including audio and video content, electronic messages (e.g., e-mail and text message) and other forms and types of electronic content. Networking-enabled devices 105, 106, 107, 110 and 115 may access and/or retrieve the electronic content by navigating to the server addresses associated with each of content servers 120. In one example, a user of PC 105 may enter a web address assigned to content server 120a into a web browser to retrieve a particular web page or site hosted by server 120a. In another example, a user of PDA 110 may identify a server address so that a messaging program may access the user's stored e-mails on a corresponding messaging server such as server 120b. Servers 120 may further include security software that may require a user to log in or authenticate their identity prior to content retrieval and/or access. In the electronic messaging example, for instance, server 120b may initially request that the user enter a username and/or password. Alternatively or additionally, servers 120 may determine whether access is authorized based on an address assigned to the requesting device/network. That is, servers 120 may deny access to devices having network or device addresses that are foreign to servers 120 or unverified. Device and network addresses may include Internet Protocol (IP) addresses and/or hardware addresses such as Media Access Control (MAC) addresses.

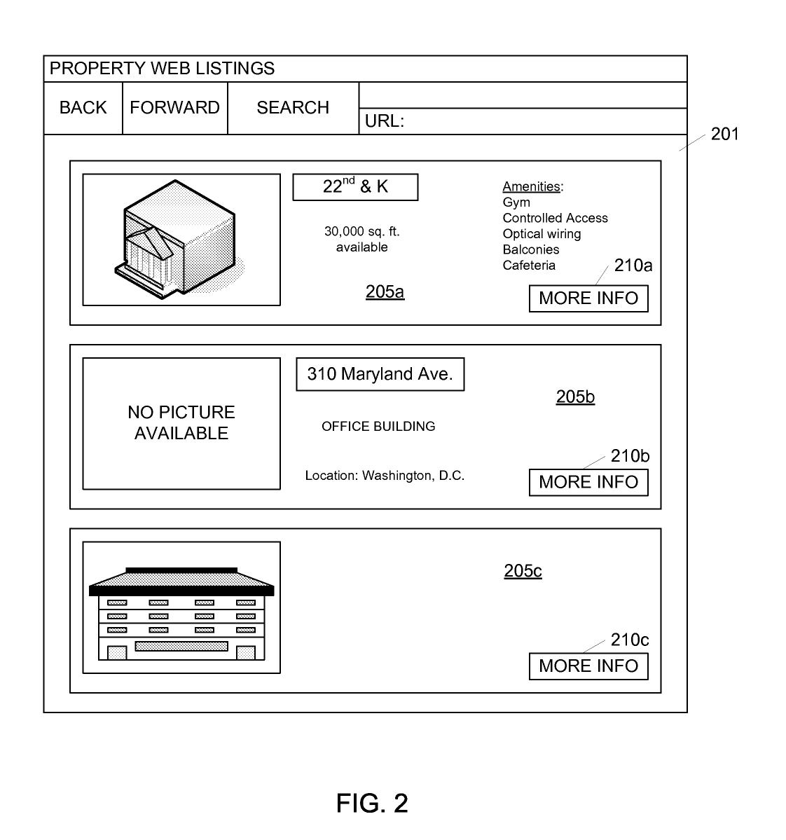

According to one or more aspects, content servers 120 may be used to post advertisements or listings of goods or properties on a global network like the Internet. Users, such as website visitors, may subsequently access servers 120 through devices 105, 110 and 115 to browse the advertisements and listings at their leisure. FIG. 2 illustrates a web site hosting a property listing web page 201 for advertising available commercial and/or residential properties. The web site and web page may be hosted by a content server such as server 120c of FIG. 1. Each property listing 205a, 205b and 205c may include one or more links 210a, 210b and 210c that a user may follow to obtain additional information and/or details about the advertised property. For example, a listing 205a might only include a picture of the property, the top 5 amenities offered by the property and a square footage available. Upon selecting link 210a, however, a user may be directed to another web page that includes further property details such as an asking price per square foot, a full listing of the buildings amenities and a specific location or address of the property. Listings 205a, 205b and/or 205c may further include a contact link that provides visitors a method of contacting the listing and/or selling party. Understandably, not every visitor may initiate contact with the listing party or advertiser. Further, those who do initiate contact do not always represent the most promising customers.

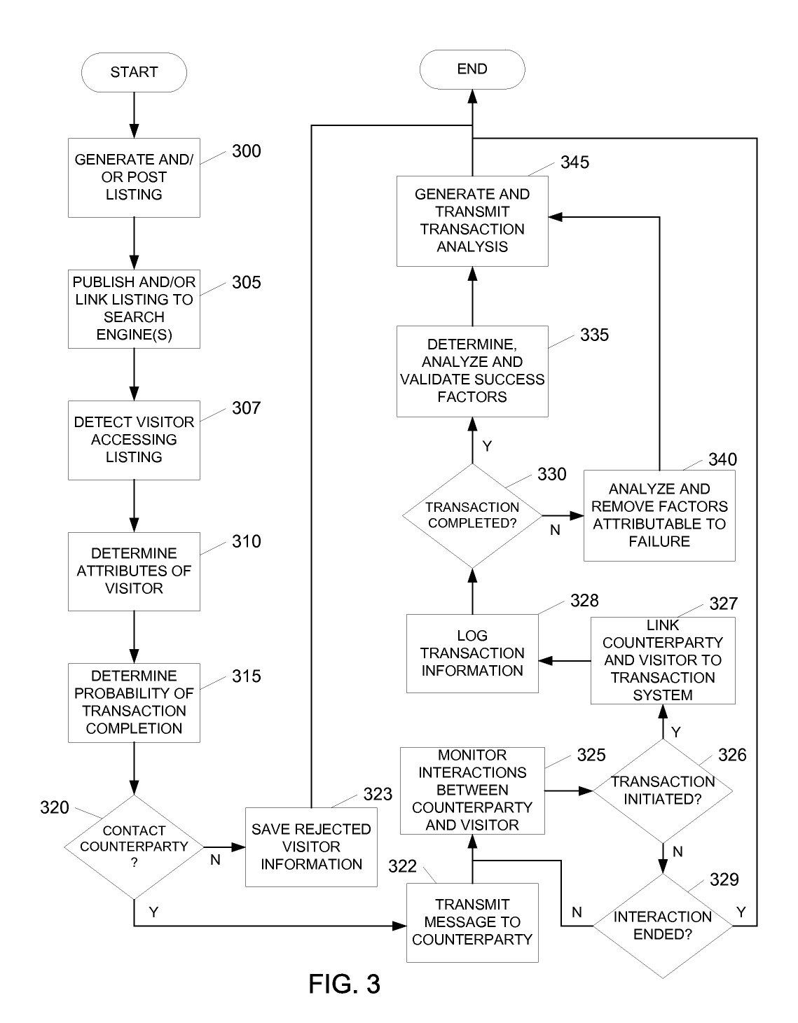

FIG. 3 illustrates a method for identifying visitors of an advertisement and/or listing and determining a probability of transaction success associated with each of the identified viewers. In step 300, a seller or a seller's representative may post an advertisement or listing on a website. In posting the listing, a listing party may be given the option to include a variety of information ranging from price of a product to amenities included in a property. In one or more instances, a listing party may be required to enter one or more of these characteristics (e.g., price, location, amenities) of the advertised product or service. In step 305, the listing or advertisement may further be published or otherwise linked to various search engines to increase visibility. For example, a listing party may add a listing to one or more search engines based on keywords associated with or used in the listing. As such, a web browser or potential customer who does not have prior knowledge of the listing or the listings web site may be made aware of the listing through a search engine.

Upon detecting a visitor accessing or viewing the listing in step 307, the server hosting the listing may identify attributes associated with the accessing visitor in step 310. Visitor attributes may be obtained in a variety of ways including requesting that each listing visitor enter specified data about themselves (e.g., e-mail address). Alternatively or additionally, if a visitor selects a contact request link associated with a listing, a dialog window may be generated requesting certain information. The collected attribute information may then be sent with the contact request. Visitors may also be required to register with the listing web site prior to being allowed access to the site. Registration may involve creating a username, a password and/or a user profile. The profile may store a variety of visitor attribute information such as name, date of birth, current residence, age, employment data and the like.

In alternative or additional configurations, visitors might not need to register or provide information about themselves. Instead, attribute information about the visitor may be retrieved from publicly available data using various network functions and/or services such as Whois queries and reverse Internet Protocol (IP) lookup services. In one scenario, when a visitor requests access to a content server (e.g., a web host), the request may include identifying information (i.e., attributes) associated with the visitor or information related to the nature of their inquiries. For example, a HTTP header in a content/access request may include a network address identifying the network from which the request originated. The network address may be used to determine publicly available domain information. Available domain information may include a domain name, an associated organization's name, as well as contact information (e.g., address, e-mail, phone number) for a person or entity associated with the organization. One of skill in the art will appreciate that a variety of identification information may be transmitted in an access or content request depending on the transmission protocol(s) used. For example, attributes such as a username or e-mail address associated with a particular visitor may be specified in a previously created and/or stored cookie. In addition, the system may retrieve other information associated with the visitor's request, such as text-based referrer codes and/or a specific reference to a type of product or service that the visitor is seeking, and that are specific to a particular user.

Visitor attributes may be either ascriptive or non-ascriptive. Ascriptive attributes relate to information that is publicly available and normally associated with the visitor such as the aforementioned domain address information, country of origin, company name and a number of times that the visitor has accessed the listing or site. Non-ascriptive attributes refer to attributes that are not generally publicly available and/or are not necessarily known to be associated with the visitor. For example, phone numbers, e-mail addresses and/or a referrer code may be information that is not publicly accessible or available and thus would be classified as non-ascriptive attributes. Non-ascriptive information may be obtained using a variety of methods including user registration and information in a referrer code such as keywords or phrases.

After the visitor has been identified, the probability that the visitor will purchase the advertised product (or rent a property or similar transaction) and/or complete a transaction is determined in step 315. Determining such a probability may help a seller or third-party such as a broker decide whether to expend the time and resources to contact and/or negotiate with the potential customer. A variety of algorithms and formulas may be used to determine a successful transaction probability including calculations based on a combination of variables and/or match criteria. Variables, as used herein, refer to fields of information such as location, gender, company type and the like. Match criteria, on the other hand, relate to the response or responses associated with each variable or field. For example, a location variable may be associated with criteria such as “Georgia, U.S.” and/or “England.” In another example, a company type variable may be associated with criteria such as “education institution” and/or “company.”

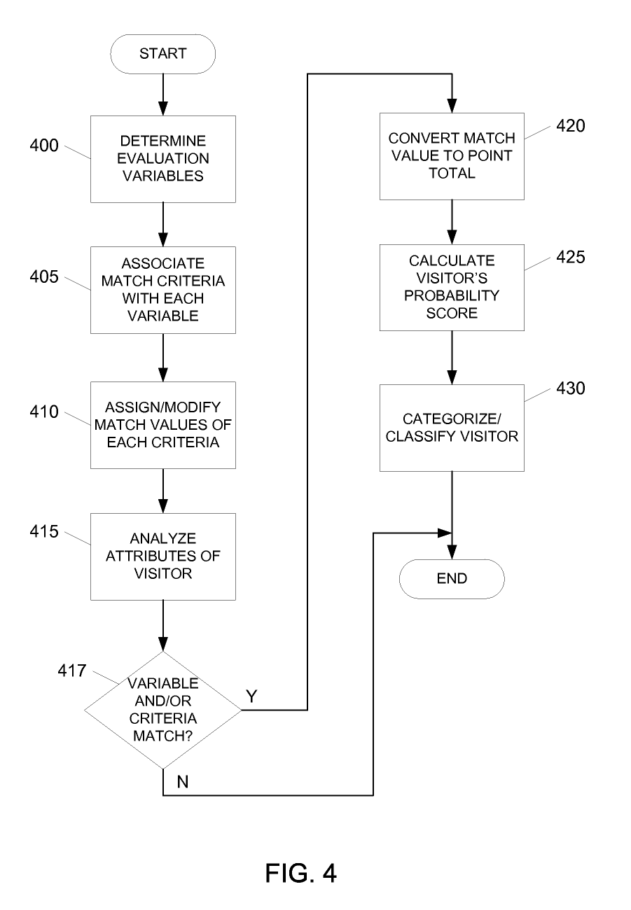

The flowchart illustrated in FIG. 4 shows one method of determining a probability that a particular user will complete a transaction. In steps 400 and 405, the server or a listing party may determine one or more variables and/or associated match criteria on which to evaluate a potential customer. In one or more arrangements, these variables and/or criteria may be derived from the information determined in step 310 of FIG. 3. For example, if a visitor's place of employment (e.g., company name and/or geographic location) is identifiable from the domain name or address based upon a “Whois” inquiry or similar online lookup system, a place of employment variable may be added to the list of evaluation variables. Additionally, if the visitor ends up completing a transaction, the visitor's place of employment, e.g., “MY COMPANY, Inc.” may be added as a match criterion to the place of employment variable. Variables and/or criteria may further be added and/or deleted based on historical transaction data that may, in one or more instances, identify variables and/or criteria that are stronger or weaker indicators of success. As an example, based on historical transaction data a place of employment variable may be determined to have no predictive value regardless of the match criteria associated therewith. As such, the place of employment variable may be deleted from the list of variables. In one or more instances, a web site may define default variables and/or match criteria for all listings hosted thereon. As such, a listing party may modify the default set of variables and/or match criteria for their listing.

Alternatively or additionally, variables and/or criteria may be determined based on the type of industry associated with the listed products or services. For example, gender may be used as a variable in determining whether a visitor will purchase a piece of clothing. Further, for male clothing, a “male” match criterion may be associated with the gender variable, so that only male visitors will be awarded a positive match value. Examples of other variables that may be used to evaluate the probability of success include a phrase match, employer name, country, number of hits by the visitor on a particular listing, previously completed transactions by the visitor and/or a URL ID associated with the visitor. In particular, phrase matches relate to a word or a phrase that a visitor may have entered or used to locate and arrive at the listing. For example, a visitor may have entered the phrase “D.C. single family homes” into a search engine to find houses in D.C. Thus, the search phrase may be used to evaluate the probability that the visitor will complete a transaction with respect to a particular listing. Variables and criteria may further be specific to a listing or may be common to all or a number of listings of a particular website. For example, a web site may define default variables for all of the listings hosted thereon. Each listing party, however, may add and remove variables to and from those default variables for specific listings. In another example, a visitor with a locus or server located in the UK would be more likely to lease commercial office space in London than someone living in another country.

Match criteria may be associated with or assigned to one or more variables based on a variety of information and data. For example, match criteria may be determined using historical transaction data. Thus, a match criteria, e.g., “non-profit organization” and a variable “organization type” that has generally been associated with successful transactions relating to suburban real estate may be associated with a central business district real estate listing. Additionally, criteria associated with or assigned to variables may be specific to individual listings or may be common to all listings on a web site or to certain groups of listings within a web site.

In step 410 of FIG. 4, the listing party or server may further modify match values assigned to each of the match criteria associated with the variables depending on the strength of each match criteria and/or variable as an indicator of success. For example, for real estate listings, a geographic location variable may be a strong indicator for success since companies and individuals are often most attracted to new properties in close proximity to the inquiring party's address. As such, match criteria associated with the geographic location variable may be assigned a greater match value than other variables. On the other hand, for clothing advertisements or listings, a gender variable may be a strong indicator for transaction success since men and women typically wear different styles. Thus, a match value associated with the gender variable may be increased or set higher than other variables associated with the same listing(s). In one or more embodiments, numeric weights may be assigned to variables and/or match criteria. That is, match values associated with a criterion or variable may be increased or decreased according to a weight. The weight may be specified as, for example, a multiplier. Thus, if a user feels that a particular variable is an especially strong indicator of success, he or she may assign a positive numeric weight to that variable while leaving the weight for the other variables unchanged. This may allow a user to adjust the relative weight of match criteria or variables without modifying the match values themselves.

Once variables, criteria and match values have been defined, one or more attributes of the visitor may be analyzed with respect to the variables and criteria in step 415. This analysis may include a comparison to determine whether an attribute of the visitor matches one or more specified variables of the listing and/or website. For example, a site or listing dedicated to commercial property may define a variable “Domain Type” that specifies one or more domain extensions such as “.com” and “.co.uk” to be considered a match. Accordingly, a visitor viewing the site or listing from the domain “mybusiness.com” may be identified as a “Domain Type” match based on matching domain extensions (i.e., “.com”). In another example, a listing may include variables such as number of previously completed transactions, number of previous visits and country. The number of previously completed transactions may be associated with a value of “greater than 1” while the number of previous visits variable may correspond to a value of “at least 3”. Further, the country variable may be associated with a criterion of “United States.”

Accordingly, upon a visitor accessing the listing, one or more of the above attributes may be determined from visitor information. Thus, the visitor may be determined to have visited the site or listing 5 previous times and to have completed no previous transactions. Additionally, the visitor's location may be identified as the United States. Based on the information determined from the visitor, matches may be found with respect to the number of previous visits variable (i.e., 5 is “at least 3”) and the country variable (i.e., United States). In contrast, since the visitor completed no previous transactions, a match would not be found and therefore no value would be recorded for this variable with regard to the previously completed transactions variable. In one or more additional or alternative arrangements, a visitor navigating to a listing from another site may carry an HTTP_REFERER code from which a variety of information about the visitor may be determined. For example, a HTTP_REFERER code may indicate that a visitor navigated to the listing from a Boston real estate listing website. Thus, the system or server hosting the listing may determine a location attribute of the visitor corresponding to a value of “Boston, Mass.” Thus, this location attribute associated with the visitor may be compared to a geographic location variable and criteria specified by the system or server.

If a variable and criteria match is found in step 417, a match value associated with the matched variable and criteria is converted to a point total in step 420. As discussed, in one or more configurations, match values may be modified by assigning a greater weight to a particular matched variable and/or criteria. Thus, if the “Domain Type” variable in the above example is determined to have twice the predictive value of other variables, the match value for matching the domain extension may be doubled. Variable and criteria weights may be reflected in the magnitude of the match value. In one example, a “Domain Type” variable match may result in the addition of 50 points whereas a “Location” variable match may be worth 75 points. The difference in match values may reflect the difference in predictive strength of the “Location” variable (or a match criteria associated therewith) as compared to the “Domain Type” variable. Match values may also be given for partial or close matches. For example, a “.org” domain extension and match criteria might only be worth half (or other percentage) the match value of a “.com” match. In another example, a domain name ending with “aol.com” may be associated with a low predictive value of completing a transaction and therefore a negative match value may be assigned to a match of the “aol.com” criteria. If, however, no criteria match is found, no points would be added to or deducted from the visitor's probability score. Steps 415, 417 and 420 may be repeated for each visitor attribute.

In step 425, after each of the visitor's attributes has been evaluated and appropriate points (i.e., match values) have been added to a visitor's probability point total, a probability score may be calculated. In one or more arrangements, the visitor's score may be simply defined as the visitor's point total for a set of matched variables or criteria. Alternatively or additionally, a probability score may be determined using a variety of algorithms and/or formulas including determining a percentage of the maximum possible point total that a visitor's point total represents. For example, if the maximum point total for a given listing or website was 300 points and a visitor was awarded 240 points, the visitor's score or probability may be defined as 80% (i.e., 240/300). Similarly, if a visitor scored 150 points out of the 300 possible points, the visitor's probability or score would be 50%. The probability scores may further be normalized on a percentage basis. A variety of other formulas and mathematical calculations may also be used in conjunction with or as an alternative to the aforementioned methods.

Based on the probability score determined in step 425, visitors may be classified or categorized according to the determined scores and/or probabilities in step 430. The level or group to which a visitor is assigned may be indicative of the visitor's potential for completing a transaction. Further, each level or group may encompass a range of scores or probabilities. For example, a visitor having a score or probability of 35% may be placed in a Level 2 category, which includes visitors having a score or probability between 25% and 50%. A visitor with a score of 77%, on the other hand, may be placed in a Level 4 category which includes visitors having a score between 75% and 100%. Alternatively, the system could display all visitors with a rank ordering of the scores. The levels and groups may be defined by a user based on preferences or, alternatively or additionally, may be determined using statistical analyses performed on historical data and trends. In one scenario, if visitors having a score of 65% are determined to be as likely to complete a transaction as a visitor having a score of 80%, a category or level may be defined that encompasses the range between 65% and 80%. The statistical analyses may be performed automatically by the server or may be initiated manually by a user.

Referring again to FIG. 3, once a visitor or potential customer's probability for completing a transaction has been evaluated and determined, a decision may be made in step 320 as to whether a counterparty associated with the listing party would be interested in contacting the visitor or a another third party related to the visitor. A counterparty generally refers to the product or property listing party and/or a third party affiliated with the counterparty including representative entities like agents. These third parties may further include brokers, advisors and the like. In one or more configurations, the contact determination may be made based on predefined rules associated with the levels or categories to which visitors may be assigned. For example, a website might only contact a counterparty if the visitor is in Level 2 or higher. Additionally, a level of contact may also be incorporated into the categories or levels. In one example, a counterparty may receive an e-mail about a Level 2 visitor or “prospect” while the counterparty is notified of a Level 3 prospect by phone. In one or more arrangements, a visitor's probability score may be compared to a predetermined threshold of qualification. The qualification threshold may correspond to a minimum probability score needed for action to be taken or contact to be initiated. In one variation, if a visitor's probability score meets the threshold, the visitor and/or the counterparty may be contacted and this activity would be duly noted and tracked through a customer contact system. Otherwise, contact might not be initiated or made.

If the system determines that the counterparty is to be contacted, the system or a user of the system may transmit one or more messages to the counterparty in step 322. A message may include an e-mail, a phone call, a voice mail message and/or a text message or another link to the listing that they had originally accessed. The message may further include a variety of information including a name of the visitor, an employer, a phone number, an address and the like. Additionally, in one or more aspects, the information is provided to allow a counterparty to contact the visitor or a third party affiliated with the visitor if he or she so desires. If, on the other hand, the system determines that the counterparty should not be contacted, the system may save the identity of the rejected visitor to a database in step 323. Alternatively, the system may perform no action if the counterparty should not be contacted.

In step 325, a system such as a contact management system may monitor and/or log the interactions between the counterparty and the visitor (or a third party affiliated with the visitor). For example, if the counter party and the visitor exchange a series of e-mails, the type and/or content of the e-mails may be tracked by the system. Further, the number of interactions (i.e., number of e-mails or messages exchanged) may also be logged by a contact management system. In step 326, the system may determine whether a transaction has been initiated. Alternatively, a system may, in one or more instances, determine that a transaction has been initiated based on the type and/or content of the message. For example, if counterparty or a visitor sends an offer to the other party, the system may determine that negotiations, and thus, a transaction, have been requested or begun. Other factors may also be used, alternatively or additionally, to evaluate whether the visitor or the counterparty wishes to engage in a transaction. These other factors may include a number of messages exchanges or interactions conducted and/or one or more keywords used in a message or interaction. Alternatively or additionally, a counterparty may send a message to both parties suggesting that they progress to more formal negotiations or to other related steps such as a visit to a property referenced in a real estate listing.

If a transaction has not been initiated, the system may further determine whether the interaction between the counterparty and the visitor has ended in step 329. One method of making such a determination is by comparing a time since last message or interaction with a threshold time interval. If the interaction has ended, the system may end pursuit of the visitor. If, on the other hand, the interaction has not ceased, the system may return to monitoring the interactions between the visitor and the counterparty in step 325.

If the system determines that either the visitor or the counterparty or both have initiated a transaction, the system may provide links to the visitor and/or the counterparty for accessing a transaction facilitation system in step 327. For example, the system or server may link the visitor and the counterparty to a transaction processing system such as a GLOBAL LEASE LINK^{SM} system that provides a basis for two parties to complete a transaction. Additional details regarding such transaction systems may be found in U.S. Pat. No. 7,024,397 to Donahue entitled “METHOD AND APPARATUS FOR NEGOTIATING A REAL ESTATE LEASE USING A COMPUTER NETWORK,” issued Apr. 4, 2006. According to one embodiment, a message such as an e-mail may be sent to both the visitor and the counterparty specifying a link to a transaction processing system in, e.g., the message. The message may further specify a transaction or meeting time during which both parties may be logged on to the system. In one or more arrangements, once the parties have been notified that they are registered in the transaction processing system, the visitor and the counterparty may interact with the transaction system individually at different times. To facilitate non-simultaneous use of the transaction system, interactions and/or interaction data may be saved for later presentation to the other party. Alternatively or additionally, one of the parties may elect to use the transaction facilitation system to generate documentation and/or to track progress in completing a transaction. Documentation may include contracts, offers, bids and/or product or property reports. The transaction processing system may track progress of the transaction and/or negotiations by logging various types of information about the transaction's progress in step 328. In one or more configurations, the transaction system may log whether the transaction was completed.

In step 330, a determination may be made as to whether a transaction was completed with the prospective customer/visitor. A transaction may be considered completed once a contract is signed or another form of binding legal agreement (e.g., a mutually binding letter of intent) is reached. If a transaction is completed with the visitor, the variables that were determined to match the visitor may be added to and/or validated in a database as success factors and/or indicators in step 335. In one or more arrangements, a database may store values indicating the relative strength of variables that correlate positively or negatively with completion. Thus, if a transaction is completed, strength values associated with each of the variables and/or values that matched the visitor may be increased for purposes of analyzing subsequent visitors to listings. For example, a visitor who lives in the same city or city vicinity as a listed property may complete a transaction associated with the listed property. Upon completion of the transaction, a location variable and/or match criteria associated therewith may be identified as a success factor and an indicator strength associated with this variable and/or the match criteria may be increased (e.g., from 50 to 75 points) accordingly. As a result, the location variable may have a more substantial impact on future visitor evaluations than before. In contrast, non-matching variables may have their indicator strengths maintained or decreased. Non-matching variables, as used herein, relate to variables that do not match a visitor's attributes. Alternatively, non-matching variables may be removed from the set of evaluation criteria entirely. Indicator strength values may, in one or more instances, correspond to the variable weights and/or match points associated with each variable.

On the other hand, if a transaction is not completed, e.g., within a specified period of time, one or more attributes associated with the visitor may be analyzed and subsequently removed from a set of evaluation variables and criteria and/or a database of success indicators in step 340. Alternatively or additionally, an indicator strength variable associated with each matching variable may be decreased. Non-matching variables may have their indicator strength values maintained or increased. For example, if a majority of listing visitors from domains ending in “.aol.com” do not end up completing a transaction, the system may remove “*.aol.com” (where * is a wildcard) from a database of success indicators. The system may alternatively specify a negative match value for matching a “*.aol.com” domain. In one or more arrangements, the amount by which an indicator strength is decreased and/or increased is based on a level of progress that was achieved in the transaction/negotiation process. Thus, in one example, if a user did not qualify to enter into the transaction system, the indicator strength may be decreased more significantly than if the transaction progressed through one or more phases of the process or reached 50% agreement on contract terms. The revised set of variables and/or criteria may then be applied in evaluating future transaction prospects and/or website visitors.

Success factors may also be determined based on the criterion or criteria associated with each variable. In other words, criteria such as New York City (for a location variable) and/or Corporation (for an organization type variable) may have transaction success/completion implications. For example, if transactions associated with property listings in Washington, D.C. are frequently completed by visitors residing in Arlington, Va., “Arlington, Va.” may be added as a criterion to a location variable associated with these listings. Alternatively or additionally, match values assigned to criteria may also be modified according to the criteria's strength as a success factor. Thus, in the above example, the location variable may store multiple criteria, e.g., “Rockville, Md.,” and “Arlington, Va.” However, a match value associated with “Arlington, Va.” may be greater than a match value associated with “Rockville Md.”

In step 345, a user or operator of the transaction system and/or web site may receive a report conveying logged transaction data and/or an analysis thereof. For example, the report may display predictive scores versus actual scores for each variable and/or criteria for a particular listing or transaction. Predictive scores may be calculated based on one or more variables and/or match criteria that in the system creator's (e.g., site host or service provider) judgment are associated with successful completion of a transaction. Actual scores, on the other hand, refer to scores determined based on transactions that are completed. The predictive vs. actual scores could be displayed on a comparative basis, permitting users to modify or eliminate certain predictive variables and/or criteria associated with a particular listing or groups of listings. Alternatively or additionally, variables associated with successfully completed transactions may be analyzed using an external database. For example, if a variable measuring proximity between the location of the visitor (based, for example, on location of his or her company) and location-based product has predictive value across various groups of listings, the system could utilize an external database that calculates the distance between localities to assist in strengthening or weakening the variable's predictive value (e.g., if the 2 locations were 10 miles apart the predictive value would be 50% less than if the locations were less than 5 miles apart). More simply, an evaluation of a common variable used across multiple listings may be performed to further refine the predictive value of the variable.

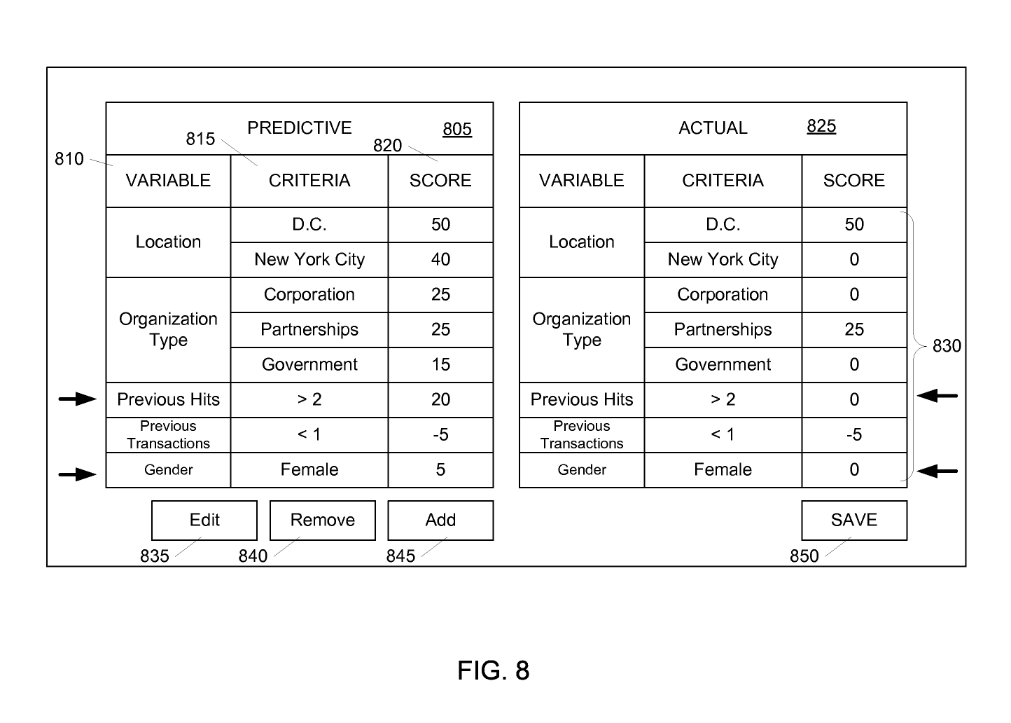

FIG. 8, for example, illustrates a user interface for comparing predictive and actual variables, criteria and scores and making modifications. Predictive table 805 displays predictive variables 810, predictive criteria 815 and predictive scores 820. Actual table 825, on the other hand, shows the actual scores 830 applied to a visitor's probability score with respect to each of the predictive variables 810 and/or criteria 815. For example, a listing party may predict that a location variable will have significant predictive value and assign the variable and the criteria associated therewith larger values (e.g., 50 and 40 points). Similarly, the listing party may also believe that a visitor's number of previous hits and gender may affect the likelihood that the visitor will complete a transaction. The listing party may thus assign an appropriate number of points to each of those variables. However, when a transaction is completed by a visitor, actual scores 830 may reveal that the gender and previous hits variables were not matched (score of 0) by the visitor while at least one of the criteria associated with the location variable was matched (score of 50). The system may thus suggest modifications to the previous hits and gender variables. For example, the system may suggest removing these variables from the predictive variables and/or decreasing their match values/scores. Alternatively or additionally, the system may suggest modifying (e.g., adding, deleting or otherwise editing) the criteria associated with those variables. Based on these suggestions and/or on the user's own preferences, variables and criteria may be modified using edit option 835, remove option 840 and add option 845. Edit option 835 may, in one or more arrangements, open a separate dialog box to allow a user to edit various properties of a variable or criteria. Alternatively, the editing may be completed within the same window. Save option 850 may further be used to save the changes made to the variables and criteria once the user is satisfied. One of skill in the art will appreciate that a variety of editing and modification options may further be added to the interface.

Referring to FIG. 3, the report of step 345 may further highlight those predictive criteria/variables that differ from the variables associated with successfully completed transactions. Suggestions may also be provided to the user regarding methods of improving the evaluation process. For example, suggestions may include removing one or more variables from and/or adding one or more variables to the set of evaluation variables.

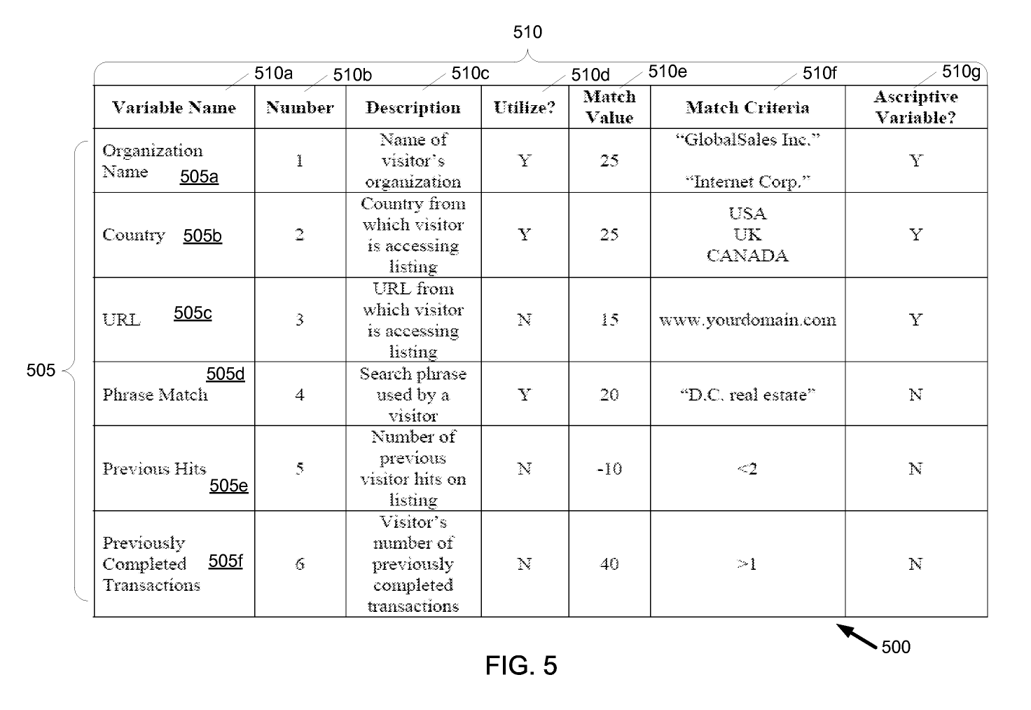

FIG. 5 illustrates a table showing a list of possible evaluation variables and criteria and properties associated therewith. Table 500 includes a listing of multiple evaluation variables 505 that are each associated with five properties 510. Particularly, evaluation variables 505 may be associated with properties 510 such as organization name 505a, country 505b, URL 505c, phrase match 505d, previous hits 505e and previous completed transactions 505f. Phrase match 505d, for instance, may be used to match a search phrase used by a visitor. Each of variables 505 may further be defined by properties 510 including variable name 510a, variable number 510b, variable description 510c, utilize/do not utilize field 510d, match value 510e, match criteria 510f and a ascriptive/non-ascriptive flag 510g. Variable name 510a, variable number 510b, and variable description 510c may be used to provide a variety of identification information while utilize/do not utilize field 510d may be used to specify whether the variable is to be evaluated. Match value 510e may specify a value that is to be applied toward a visitor's score if the visitor matches the variable and a criterion thereof. Further, match criteria 510f identify one or more criteria that are considered matches for the variable. Thus, if a visitor matches one or more criteria (e.g., UK, US, China) of country variable 505b, the match value assigned to country 505b and/or the matched criterion may be applied to the visitor's probability score. Match value 510e may correspond to and/or represent a relative importance or significance of the variable or criteria associated therewith. According to one or more aspects, table 500 may be stored in a database of the transaction system or in a separate database. Properties 510, variables 505 and/or values thereof may further be added, deleted and/or otherwise modified.

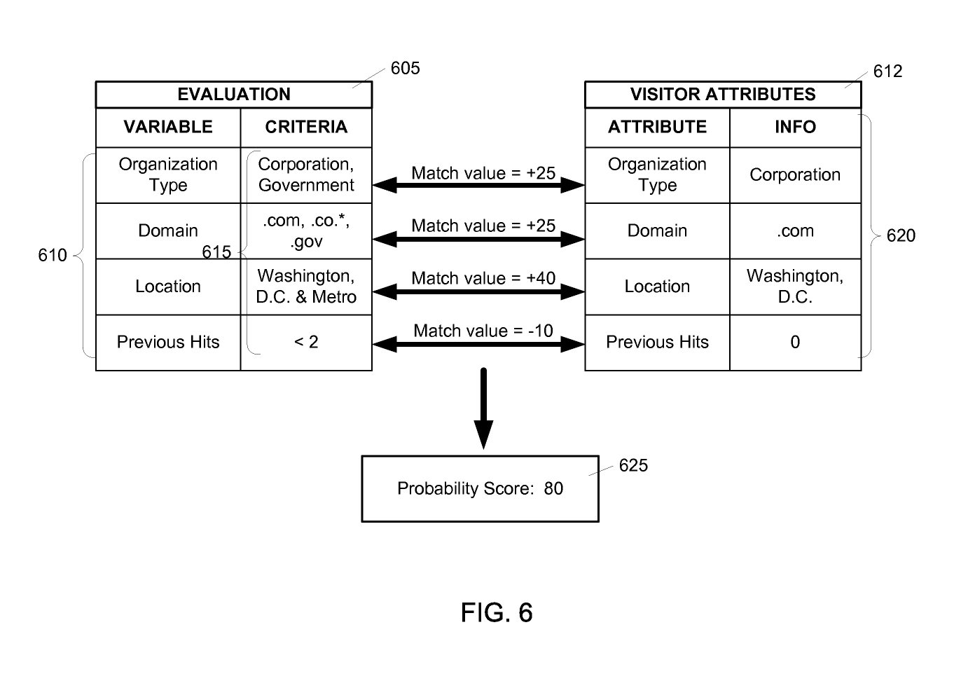

FIG. 6 is a graphical representation of a process for evaluating a transaction potential of a visitor. Block 605 represents a set of evaluation variables 610 and corresponding match criteria 615 associated with a listing on a website. Block 612 represents attribute information 620 of a visitor viewing the listing. To evaluate the probability that the visitor will complete a proposed transaction, variables 610 and match criteria 615 may be compared with attributes 620 of the visitor. A probability score 625 may be determined based on a number of matches between variables 610 and match criteria 615 with attributes 620 and calculating a match value associated with each match. In one example, matching a location variable corresponds to a match value of 40 points while matching an organization type corresponds to a match value of 25 points, signifying the difference in relative weights attached to each variable. In contrast, matching the previous hits variable and criteria may result in a deduction of points of 10 points. For example, a listing party may specify that if a visitor has not visited the listing more than once, the probability that the visitor will complete a transaction should be lowered. These match values may be applied (e.g., added and/or subtracted) to the visitor's probability score. Thus, in the example of FIG. 6, the visitor's probability score would be 80 points.

Further, in one or more variations, an equal number of match value points may be assigned to each variable and criteria but with a different weight applied to each of these matches. Score 625 may subsequently be used to represent the probability that the visitor will complete a transaction. Alternatively or additionally, score 625 may determine whether the visitor is to be contacted and if so, to what extent. Such a determination may be based on a predefined qualification threshold for initiating visitor contact. For example, a visitor with a probability score of 75 points or lower might not be worth contacting. On the other hand, a visitor with a mediocre score might be worth contacting but only by sending an e-mail or letter. Various alternative or additional rules may be defined based on determined score or probability 625.

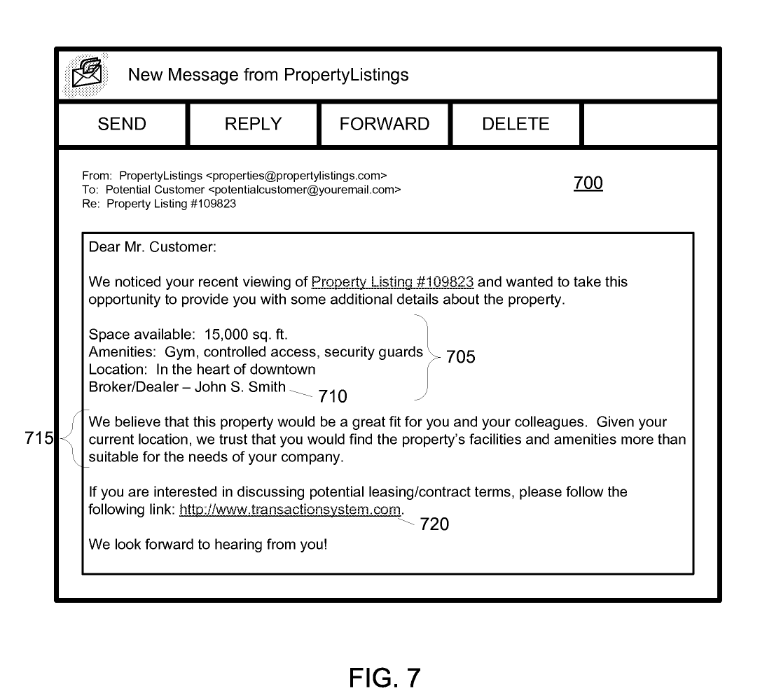

FIG. 7 illustrates a message that may be sent to one or more visitors that exceed a predefined contact threshold or threshold of qualification. In other words, if a contact management system determines that a visitor has a sufficiently high probability for completing a transaction or has provided an indication that they wish to initiate a transaction, the counterparty (i.e., listing party or an affiliated third party such as an agent of the listing party) may send a message such as e-mail 700 to the visitor. E-mail 700 may include various types of information including data 705 relating to the property the visitor viewed, name of the counterparty (e.g., broker or seller) 710, personal message 715 and/or link 720 for connecting the visitor to a transaction facilitation system. In one or more configurations, name 710 of the counterparty might not be revealed in e-mail 700. Instead, the counterparty information might only be revealed upon the visitor selecting link 720 for connecting to the transaction system. Other types of messages may also be sent including letters, text messages and/or video messages that include alternative or additional types of information that may be integrated into a contact management system. Messages and other interactions exchanged between a visitor and a counterparty may be logged and stored in a contact management system with information identifying the source of the message or interaction.

While the systems and methods described herein have been explained, in large part, with respect to real estate web sites and properly listings, one of skill in the art will appreciate that such systems and methods may be used in conjunction with other types of products and services. For example, listings for automobiles and/or jobs may also benefit from predictive evaluation of potential buyers or employees. These other types of listings may include a variety of industry-specific variables and/or match values for evaluating prospective clients (e.g., visitors). According to another aspect, evaluation variables and/or criteria associated with a listing may be negative rather than positive. That is, matching a negative variable may decrease the predicted probability that the visitor will complete a transaction.

The present invention has been described in terms of preferred and exemplary embodiments thereof. Numerous other embodiments, modifications and variations within the scope and spirit of the appended claims will occur to persons of ordinary skill in the art from a review of this disclosure. The invention also includes computer-readable media having computer-executable instructions that embody any of the methods disclosed herein.

1. A method for facilitating a transaction, comprising the steps of:
receiving, from a web-based listing that describes a product or service, information associated with a first party interested in the product or service, wherein the information is determined upon the first party viewing the web-based listing;
automatically classifying the first party based in part on the information associated with the first party, wherein the classification is performed on the basis of an algorithmic formula applying values to one or more criteria derived from the information associated with the first party; and
in response to determining that the first party exceeds a predetermined threshold of qualification, contacting a second party associated with the product or service and facilitating a proposed transaction between the first party and the second party.

2. The method of claim 1, further comprising the step of linking the first party and the second party to a transaction system that facilitates the transaction for purchasing the product or service.

3. The method of claim 1, further comprising the steps of:
storing information relating to the proposed transaction associated with the product or service;
analyzing one or more success factors based on the stored transaction information; and
adjusting the values based on the analysis of the one or more success factors for predicting successful transactions.

4. The method of claim 1, wherein the product or service comprises a real estate property.

5. The method of claim 1, wherein the automatically classifying step comprises the step of performing a reverse Internet Protocol lookup on the information associated with the first party and identifying a representative entity affiliated with the first party.

6. The method of claim 1, wherein the step of facilitating the proposed transaction between the first party and the second party includes sending a message to the first party, wherein the message includes information for accessing a transaction system.

7. The method of claim 1, wherein the step of facilitating the proposed transaction includes monitoring interactions between the first party and the second party.

8. The method of claim 1, further comprising the step of revising the algorithmic formula based on whether the first party and the second party completed the proposed transaction.

9. The method of claim 8, wherein the step of revising the algorithmic formula includes modifying one or more success factors.

10. The method of claim 8, wherein the step of revising the algorithmic formula includes modifying the match values associated with the one or more criteria.

11. The method of claim 1, wherein the second party includes at least one of a party entering a web-based listing and a representative entity associated therewith.

12. A method for facilitating a transaction, comprising the steps of:
receiving a request from a first party to view a web-based listing that describes a product or service;
identifying one or more attributes of the first party based on information received in the request;
determining a probability that the first party will complete a proposed transaction based on a comparison of the one or more identified attributes and a set of one or more predefined evaluation variables;
automatically classifying the first party based on the determined probability; and
in response to determining that the determined probability of the first party exceeds a predetermined probability threshold, facilitating the proposed transaction between the first party and the second party.

13. The method of claim 12, wherein the step of facilitating the proposed transaction includes contacting the first party.

14. The method of claim 12, wherein the information received in the request includes an Internet Protocol (IP) address associated with the first party.

15. The method of claim 12, wherein at least one of the one or more attributes is determined based on a HTTP_REFERER code.

16. The method of claim 12, wherein the one or more attributes includes at least one of an ascriptive attribute and a non-ascriptive attribute.

17. The method of claim 12, wherein the one or more attributes includes at least one of a name, a gender, an originating domain name and an organization type.

18. The method of claim 12, wherein the step of facilitating the proposed transaction between the first party and the second party includes linking the first party and the second party to a transaction system.

19. The method of claim 12, wherein the step of determining a probability that the first party will complete a proposed transaction further includes:
determining whether a first attribute of the one or more identified attributes matches a first criteria of the one or more evaluation variables; and
in response to determining that the first attribute matches the first criteria, applying a first match value associated with the first criteria to the probability that the first party will complete the proposed transaction.

20. The method of claim 19, wherein the first match value is negative.

21. The method of claim 12, further comprising the step of revising the set of one or more predefined evaluation variables based on whether the first party and the second party completed the proposed transaction.

22. The method of claim 21, wherein the step of revising the set of one or more predefined evaluation variables is further based on transaction information associated with a plurality of completed transactions.

23. The method of claim 21, wherein the step of revising the set of one or more predefined evaluation variables further includes retrieving data from an external database.

24. The method of claim 21, wherein the step of revising the set of one or more predefined evaluation variables includes removing a variable from the set.

25. The method of claim 21, wherein the step of revising the set of one or more predefined evaluation variables includes modifying a match value associated with at least one variable of the set.

26. A computer readable medium storing computer readable instructions that, when executed, cause a processor to perform a method comprising the steps of:
receiving, from a web-based listing that describes a product or service, information associated with a first party interested in the product or service, wherein the information is determined based on the first party viewing the web-based listing;
automatically classifying the first party based in part on the information associated with the first party, wherein the classification is performed on the basis of an algorithmic formula applying values to one or more criteria derived from the information associated with the first party;
in response to determining that the first party exceeds a predetermined threshold of qualification, facilitating a proposed transaction between the first party and the second party; and
revising the algorithmic formula based on whether the first party and the second party completed the proposed transaction.

27. The computer readable medium of claim 26, wherein the step of revising the algorithmic formula includes the step of modifying one or more weights associated with the one or more criteria.

28. The computer readable medium of claim 27, wherein the step of modifying one or more weights associated with the one or more criteria is based on whether the information associated with the first party matched the one or more criteria.

29. The computer readable medium of claim 26, wherein the step of revising the algorithmic formula includes the step of modifying the predetermined threshold of qualification.
